(19) United States
(12) Patent Application Publication
(10) Pub. No.: US 2017/0046965 A1
(43) Pub. Date: Feb. 16, 2017

(54) ROBOT WITH AWARENESS OF USERS AND ENVIRONMENT FOR USE IN EDUCATIONAL APPLICATIONS

(71) Applicant: Intel Corporation, Santa Clara, CA (US)

(72) Inventors: GILA KAMHI, Zichron Yaakov (IL); AMIT MORAN, Tel Aviv (IL)

(73) Assignee: INTEL CORPORATION, Santa Clara, CA (US)

(21) Appl. No.: 14/824,632

(22) Filed: Aug. 12, 2015

(51) Int. Cl. G09B 5/06; G06K 9/46; G06F 3/01; G06K 9/00

(52) U.S. Cl. CPC G09B 5/067; G06K 9/00288; G06K 9/46; G06F 3/017; G06K 9/00315

(57) ABSTRACT

Generally, this disclosure provides systems, devices, methods and computer readable media for user and environment aware robots for use in educational applications. A system may include a camera to obtain image data and user analysis circuitry to analyze the image data to identify a student and obtain educational history associated with the student. The system may also include environmental analysis circuitry to analyze the image data and identify a projection surface. The system may further include scene augmentation circuitry to generate a scene comprising selected portions of the educational material based on the identified student and the educational history; and an image projector to project the scene onto the projection surface.

### FIELD

The present disclosure relates to robots in educational applications, and more particularly, to robots with awareness of users and the environment, for use in educational or training applications.

### BACKGROUND

Robots are playing an increasing role in educational settings and applications. For example, robots are being used to facilitate sharing of ideas among students, data collection and problem solving. Their use in a classroom environment may encourage children to develop social skills and learn to work in teams. Some of these robots exhibit human-like features (humanoid robots) to provide a more comfortable and familiar experience for the student. Existing educational robots are generally limited, however, in their modes of interaction with the students and their ability to dynamically adapt to varying environments in the classroom and changing needs of the students.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates an implementation scenario of a system consistent with an example embodiment the present disclosure;

FIG. 2 illustrates a top level system block diagram of an example embodiment consistent with the present disclosure;

FIG. 3 illustrates a block diagram of an example embodiment consistent with the present disclosure;

FIG. 4 illustrates another block diagram of an example embodiment consistent with the present disclosure;

FIG. 5 illustrates a flowchart of operations of one example embodiment consistent with the present disclosure;

FIG. 6 illustrates a flowchart of operations of another example embodiment consistent with the present disclosure; and

FIG. 7 illustrates a system diagram of a platform of another example embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems, devices, methods and computer readable media for user and environment aware robots for use in educational applications. In some embodiments, a robot may include a camera, for example a three dimensional (3-D) camera, also known as a depth camera, configured to obtain images of the students and the classroom environment. The student images may be analyzed to recognize and identify the students, to obtain educational history on the students and to estimate the state of attention of the students. This information may be used to enhance the teaching materials that are to be presented. The robot may also include a projector configured to project or display scenes onto any suitable surface in the classroom. These scenes may include the enhanced teaching materials. Identification of suitable surfaces for projection may be accomplished through further analysis of the images of the classroom environment. In some embodiments, the robot may be configured to obtain and analyze content of student devices (e.g., tablets, laptops, etc.) that may be relevant to the current teaching assignment, and the enhanced teaching materials may be further updated based on such content. These capabilities for dynamically adapting based on awareness of users and environment, may allow the students to interact with the robot in a more natural manner, for example as they would with a human teacher.

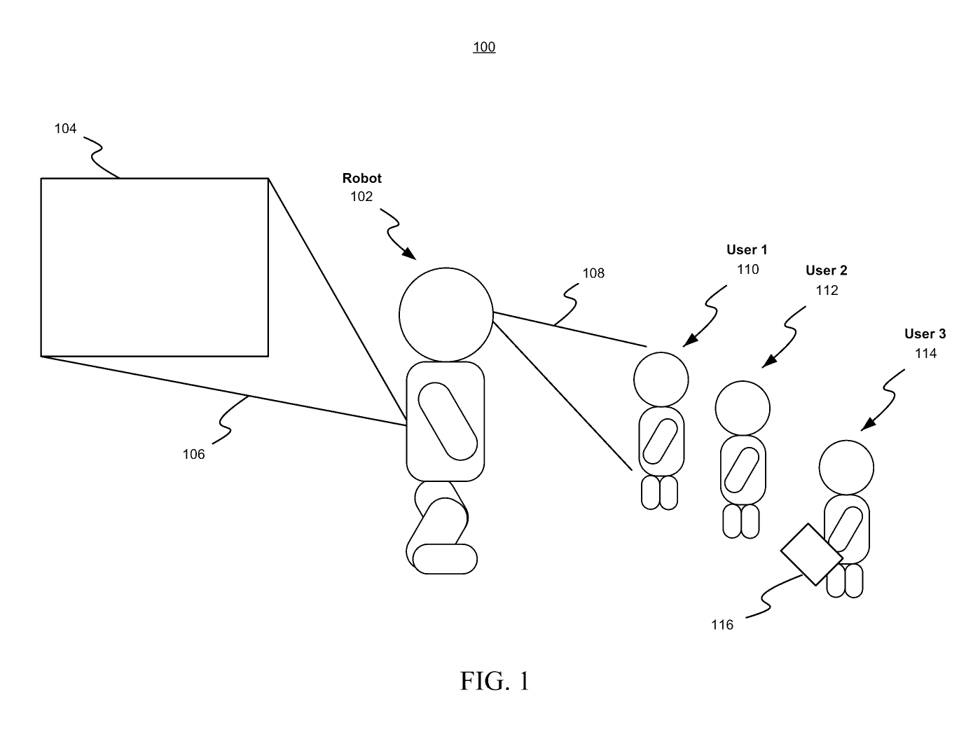

FIG. 1 illustrates an implementation scenario 100 of a system consistent with an example embodiment the present disclosure. A robot 102, for example a teaching robot, is shown in a classroom environment that includes a number of users or students 110, 112, 114. In some embodiments, the robot 102 may be a humanoid robot, for example a robot configured in appearance to possess certain features and characteristics of a human. Such an appearance may facilitate interaction between the robot 102 and students 110, 112, 114. The robot may be configured to interact with the students and provide enhanced educational material, as will be described in greater detail below.

Some students may also interact with a device 116 such as, for example, a tablet or laptop, which may provide additional educational material. The robot may be configured to communicate with devices 116 to monitor and analyze that content. The robot may be further equipped with a camera configured to view 108 any portion of the classroom environment including any of the students. The camera may be configured to provide 3-D images. The robot may also be equipped with a projector configured to project scenes 106 onto any suitable surface 104 in the environment. The scenes may be designed and composed by the robot to include educational material relevant to the current teaching tasks and further based on an analysis of the images of the classroom environment, the students and/or the content of devices 116.

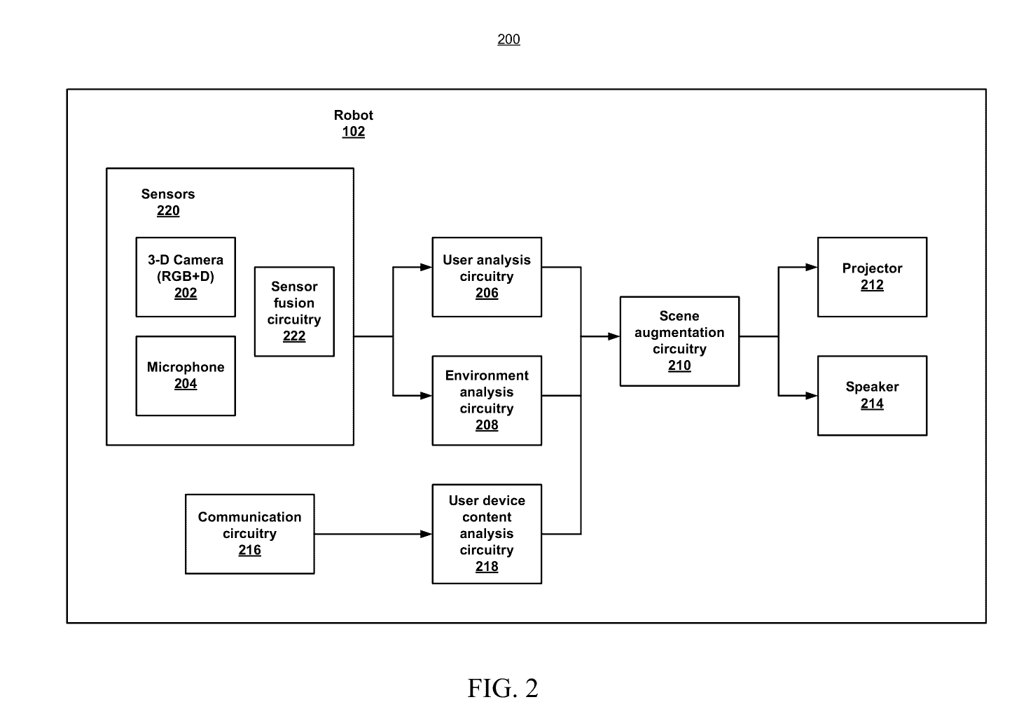

FIG. 2 illustrates a top level system block diagram 200 of an example embodiment consistent with the present disclosure. The robot 102 is shown to include sensors 220, user analysis circuitry 206, environment analysis circuitry 208, scene augmentation circuitry 210 and a projector 212 and speaker 214. The sensors 220 may include a 3-D camera 202, a microphone 204 and sensor fusion circuitry 222, along with any other suitable type of sensor (not shown). In some embodiments, the robot 102 may also include communication circuitry 216 and user device content analysis circuitry 218.

The sensors may be configured to provide information about the environment (e.g., classroom setting) and users (e.g., students). The 3-D camera 202, for example, may provide image data to the user analysis circuitry and the environment analysis circuitry. The 3-D camera 202 may be configured to including color (red-green-blue or RGB) data and depth data as part of the image. The user analysis circuitry 206 may be configured to recognize and identify a student and to estimate state information associated with the student (e.g., state of attention), based on the image data, as will be described in greater detail below. In some embodiments, the student's speech, provided by microphone 204, may also be used to aid in the identification of the student. The recognized student may also be tracked if he moves around the classroom. The user analysis circuitry 206 may also be configured to obtain information about the educational history and background of the identified student, for example what the student might be expected to already know. In some embodiments, the sensors 220 may include sensor fusion circuitry 222 configured to combine data from the available sensors such that the data are aligned relative to each other and time stamped. For example, the RGB data and depth data may need to be aligned to create an RGB+D image.

The environment analysis circuitry 208 may be configured to analyze the image data to obtain information about the classroom setting including potential projection surfaces (e.g., walls, floors, ceiling, table, etc.) and objects that may be related to or incorporated in the teaching material to be presented by the robot.

Communication circuitry 216 may be configured to communicate with devices 116 used by the students (e.g., tablets, laptops, etc.) that provide additional educational material content. In some embodiments, the communication may be wireless and may conform to any suitable communication standards such as, for example, WiFi (Wireless Fidelity), Bluetooth or NFC (Near Field Communications). User device content analysis circuitry 218 may be configured to analyze the educational content displayed by the device 116 to the student to determine if such content may be relevant to or may be incorporated or supplemented in the teaching material to be presented by the robot.

Scene augmentation circuitry 210 may be configured to generate a scene (e.g., a video and/or audio presentation) that includes educational material tailored to or otherwise based on the identified student, the student's estimated state of attention, the student's educational history, the analyzed content of the student's device and/or any detected objects in the classroom that are determined to be relevant. The generated scene may be delivered to the student and the classroom through projector 212 and/or speaker 214. The scene may be projected onto one of the surfaces identified by environment analysis circuitry 208.

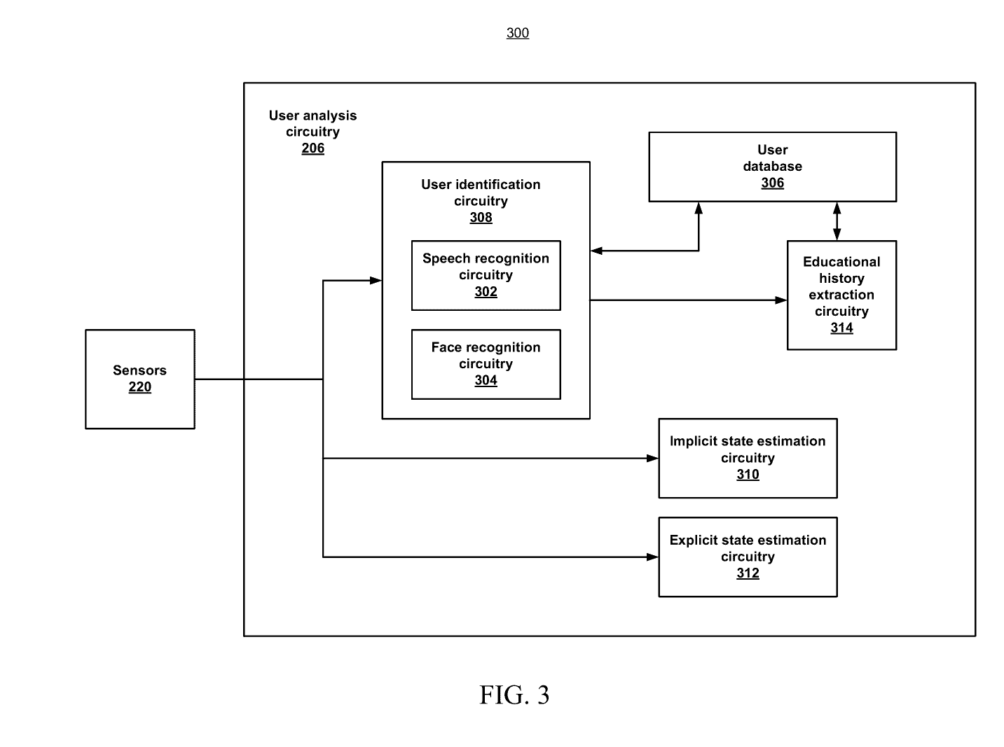

FIG. 3 illustrates a block diagram 300 of an example embodiment consistent with the present disclosure. User analysis circuitry 206 is shown in greater detail to include user identification circuitry 308, implicit state estimation circuitry 310, explicit state estimation circuitry 312, a user database 306 and educational history extraction circuitry 314. User identification circuitry 308 may further include speech recognition circuitry 302 and face recognition circuitry 304.

Face recognition circuitry 304 and speech recognition circuitry 302, may be configured to receive image data and audio data, respectively, from sensors 220, and to generate features or other suitable information based on that data, for use in identifying a student. Any suitable existing, or yet to be developed, speech recognition and face recognition technology may be employed. User identification circuitry 308 may be configured to search user database 306 to find and identify a recognized student. The search may be based on the features, or other information, generated by the speech and/or face recognition circuitry 302, 304. Educational history extraction circuitry 314 may be configured to obtain any available educational history or background information, associated with the identified student, which may be in the user database 306. The education presentation (e.g., the projected scenes) may thus be adapted to the student's educational history. For example, material that is already known may not need to be repeated, or may be more quickly reviewed.

Implicit state estimation circuitry 310 may be configured to receive image data from 3-D camera 202 and estimate the cognitive and emotional state of the student based on features extracted from the image data, such as, for example, head pose, posture, facial expression and speech. The delivery of educational material may be adjusted based on this implicit state. For example, if the student's state of attention is relatively high, the presentation speed may be increased or augmented with additional more advanced material. Alternatively, if the student's state of attention is relatively low, the presentation speed may be decreased or additional background or explanatory material may be presented to assist with any potential confusion the student may be experiencing.

Explicit state estimation circuitry 312 may be configured to receive image data from 3-D camera 202 and recognize and track hand and facial gestures of the student based on the image data. Explicit state estimation circuitry 312 may further be configured to associate the gestures with commands. Commands may also be detected through speech recognition. The commands may be selected, for example, from a list of pre-determined or known user commands. Some examples of commands may include pausing of the presentation, speeding up or slowing down the presentation, signaling the need for further explanation of a topic, adjusting the volume, etc.

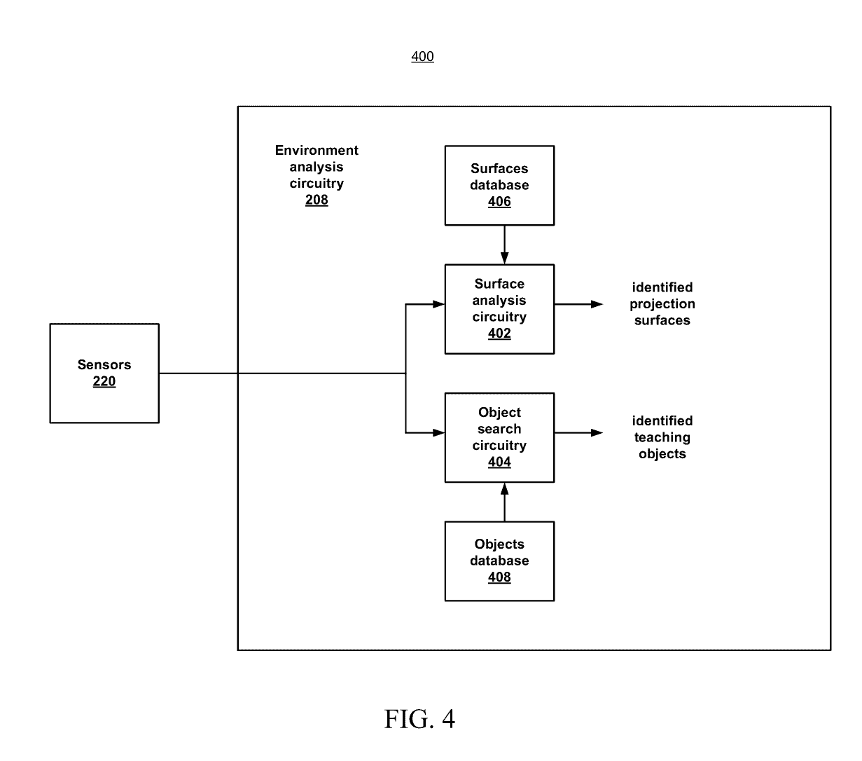

FIG. 4 illustrates another block diagram 400 of an example embodiment consistent with the present disclosure. Environment analysis circuitry 208 is shown in greater detail to include surface analysis circuitry 402, a surfaces database 406, object search circuitry 404 and an objects database 408.

Surface analysis circuitry 402 may be configured to receive image data from 3-D camera 202 and analyze the data to search for potential surfaces onto which educational scenes may be projected. Surfaces may include, for example, walls, ceilings, whiteboards, table tops, etc. Surface database 406 may be used to store the location of suitable discovered surfaces and/or provide guidance for the search based on previously supplied information about the classroom setting.

Object search circuitry 404 may be configured to receive image data from 3-D camera 202 and analyze the data to search for potential objects that may be relevant in the context of the educational material to be presented or in the context of the educational material on the user's device. For example, in the context of a lesson about gravity, the search may discover the existence of a pendulum in the classroom, which may then be incorporated into the presented material (e.g., the augmented scene). Similarly, in the context of a lesson about the alphabet, the search may discover wooden letters and numbers. Object database 408 may be used to store information about the discovered objects and/or provide guidance for the object search based on previously supplied information about the classroom setting and what the robot might be expected to find.

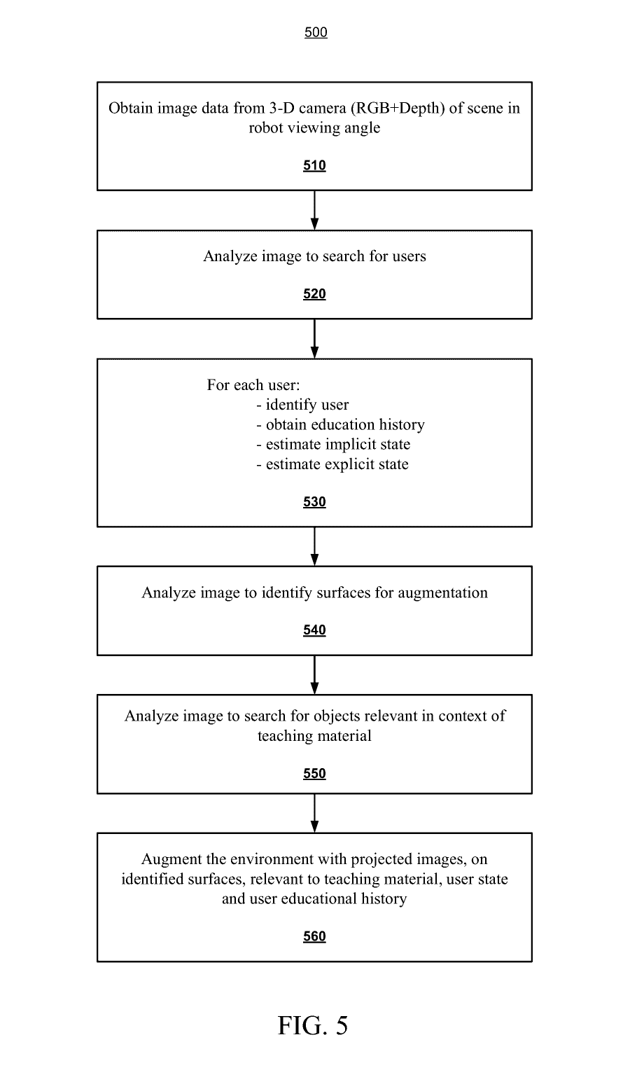

FIG. 5 illustrates a flowchart of operations 500 of one example embodiment consistent with the present disclosure. The operations provide a method for user and environment aware robot interaction in educational applications. At operation 510, image data is obtained from a 3-D camera, including color (RGB) and depth data associated with a scene in the viewing angle of the robot. At operation 520, the image data is analyzed to search for users. At operation 530, for each user detected in the image: the user is recognized and identified, an educational history is obtained for that user, an implicit state of the user is estimated, and an explicit state of the user is estimated. The implicit state may include head pose, posture and facial expression. The explicit state may include gestures associated with commands. At operation 540, the image data is further analyzed to identify surfaces for augmentation. At operation 550, the image data is further analyzed to search for objects relevant in the context of the current teaching material. At operation 560, the environment is augmented with projected images relevant to the current teaching material and detected objects and further based on the user's educational history and estimated implicit/explicit state.

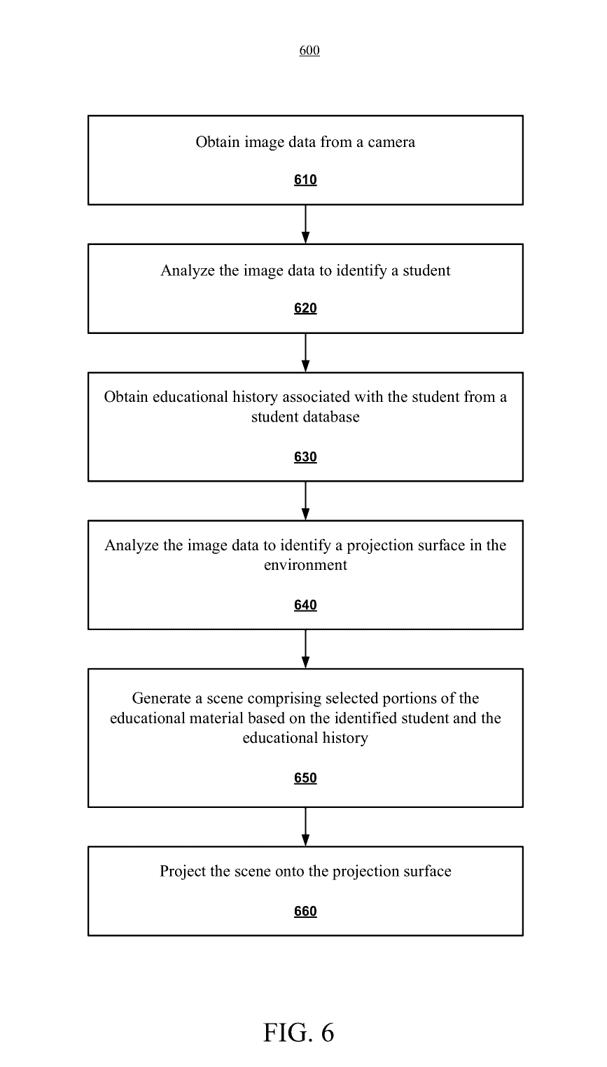

FIG. 6 illustrates a flowchart of operations 600 of one example embodiment consistent with the present disclosure. The operations provide a method for user and environment aware robot interaction in educational applications. At operation 610, image data is obtained from a camera. At operation 620, the image data is analyzed to identify a student. At operation 630, educational history associated with the student is obtained from a student database. At operation 640, the image data is analyzed to identify a projection surface in the classroom environment. At operation 650, a scene comprising selected portions of the educational material is generated based on the identified student and the educational history. At operation 660, the scene is projected onto the projection surface.

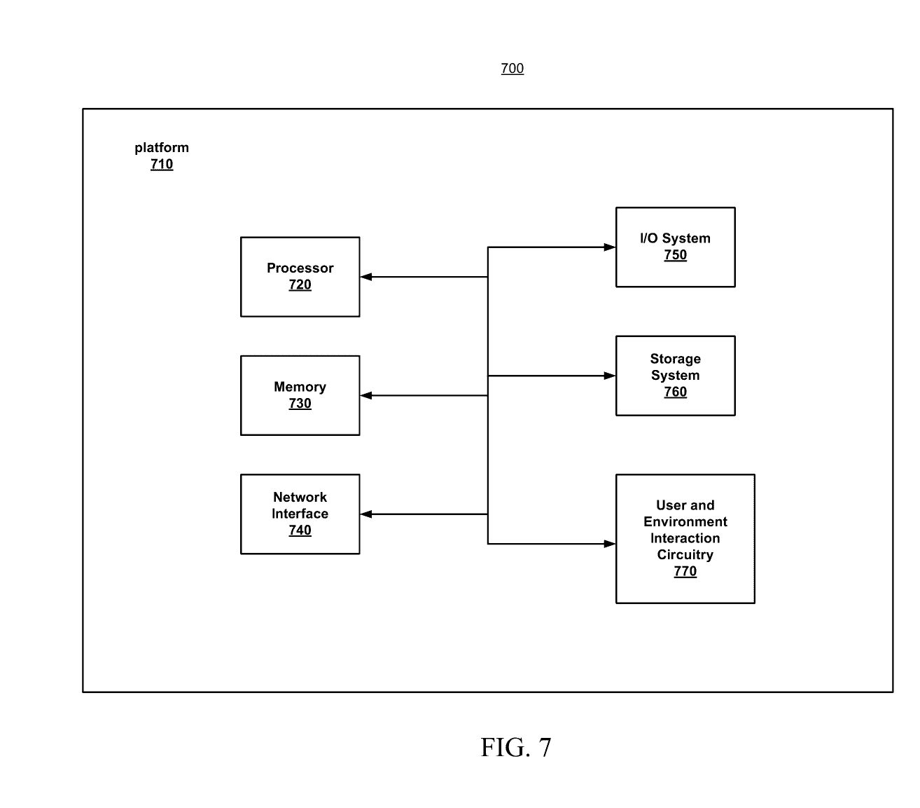

FIG. 7 illustrates a system diagram 700 of one example embodiment consistent with the present disclosure. The system 700 may be a computing platform 710 configured to host the functionality of the robot 102 as described previously. It will be appreciated, however, that embodiments of the system described herein are not limited to robots, and in some embodiments, the system 700 may be a workstation, desktop computer laptop computer, communication, entertainment or any other suitable type of device such as, for example, a smart phone, smart tablet, personal digital assistant (PDA), mobile Internet device (MID), convertible tablet, or notebook.

The system 700 is shown to include a processor 720 and memory 730. In some embodiments, the processors 720 may be implemented as any number of processors or processor cores. The processor (or core) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. The memory 730 may be coupled to the processors. The memory 730 may be any of a wide variety of memories (including various layers of memory hierarchy and/or memory caches) as are known or otherwise available to those of skill in the art. It will be appreciated that the processors and memory may be configured to store, host and/or execute one or more user applications or other software. These applications may include, but not be limited to, for example, any type of computation, communication, data management, data storage and/or user interface task. In some embodiments, these applications may employ or interact with any other components of the platform 710.

System 700 is also shown to include network interface circuitry 740 which may include wired or wireless communication capabilities, such as, for example, Ethernet, cellular communications, Wireless Fidelity (WiFi), Bluetooth®, and/or Near Field Communication (NFC). The network communications may conform to or otherwise be compatible with any existing or yet to be developed communication standards including past, current and future version of Ethernet, Bluetooth®, Wi-Fi and mobile phone communication standards. The network interface 740 may be configured to communicate with any other user devices, such as for example, a tablet that the user accesses to obtain educational material as previously described.

System 700 is also shown to include an input/output (IO) system or controller 750 which may be configured to enable or manage data communication between processor 720 and other elements of system 700 or other elements (not shown) external to system 700, including sensors 220, projector 212 and speaker 214. System 700 is also shown to include a storage system 760, which may be configured, for example, as one or more hard disk drives (HDDs) or solid state drives (SSDs).

System 700 is also shown to include user and environment interaction circuitry 770 configured to provide user and environment awareness capacities, as previously described. Circuitry 770 may include any of circuits 206, 208, 210 and 218, as previously described in connection with FIG. 2.

It will be appreciated that in some embodiments, the various components of the system 700 may be combined in a system-on-a-chip (SoC) architecture. In some embodiments, the components may be hardware components, firmware components, software components or any suitable combination of hardware, firmware or software.

“Circuitry,” as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Other embodiments may be implemented as software executed by a programmable control device. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Any of the operations described herein may be implemented in one or more storage devices having stored thereon, individually or in combination, instructions that when executed by one or more processors perform one or more operations. Also, it is intended that the operations described herein may be performed individually or in any sub-combination. Thus, not all of the operations (for example, of any of the flow charts) need to be performed, and the present disclosure expressly intends that all sub-combinations of such operations are enabled as would be understood by one of ordinary skill in the art. Also, it is intended that operations described herein may be distributed across a plurality of physical devices, such as processing structures at more than one different physical location. The storage devices may include any type of tangible device, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions.

Thus, the present disclosure provides systems, devices, methods and computer readable media for user and environment aware robots for use in educational applications. The following examples pertain to further embodiments.

According to Example 1 there is provided a system for providing educational material. The system may include: a camera to obtain image data; user analysis circuitry to analyze the image data to identify a student and obtain educational history associated with the student; environmental analysis circuitry to analyze the image data and identify a projection surface; scene augmentation circuitry to generate a scene including selected portions of the educational material based on the identified student and the educational history; and an image projector to project the scene onto the projection surface.

Example 2 may include the subject matter of Example 1, and the user analysis circuitry further includes implicit state estimation circuitry to estimate a state of attention of the student based on features of the student extracted from the image data, the features including head pose, posture and facial expression; and the selected portions of the educational material are further based on the estimated state of attention.

Example 3 may include the subject matter of Examples 1 and 2, and the user analysis circuitry further includes explicit state estimation circuitry to estimate gestures of the student based on the image data, the gestures associated with commands; and the scene augmentation circuitry is further to modify the scene based on the estimated gestures.

Example 4 may include the subject matter of Examples 1-3, and the environmental analysis circuitry further includes object search circuitry to identify objects associated with the educational material in the image data; and the scene augmentation circuitry is further to modify the scene to incorporate the identified objects.

Example 5 may include the subject matter of Examples 1-4, further including communication circuitry to communicate with a device of the student; and content analysis circuitry to analyze educational content displayed by the device; and the scene augmentation circuitry is further to modify the scene based on the analyzed educational content.

Example 6 may include the subject matter of Examples 1-5, and the camera is a depth camera and the image data is 3-Dimensional.

Example 7 may include the subject matter of Examples 1-6, further including a microphone to obtain input audio data from the student and speech recognition circuitry to further identify the student based on the input audio data.

Example 8 may include the subject matter of Examples 1-7, further including a speaker to generate output audio associated with the selected portions of the educational material.

Example 9 may include the subject matter of Examples 1-8, and the system is a humanoid robot.

According to Example 10 there is provided a method for providing educational material in a classroom environment. The method may include: obtaining image data from a camera; analyzing the image data to identify a student; obtaining educational history associated with the student from a student database; analyzing the image data to identify a projection surface in the environment; generating a scene including selected portions of the educational material based on the identified student and the educational history; and projecting the scene onto the projection surface.

Example 11 may include the subject matter of Example 10, further including estimating a state of attention of the student based on features of the student extracted from the image data, the features including head pose, posture and facial expression; and the selected portions of the educational material are further based on the estimated state of attention.

Example 12 may include the subject matter of Examples 10 and 11, further including estimating gestures of the student based on the image data, the gestures associated with commands; and modifying the scene based on the estimated gestures.

Example 13 may include the subject matter of Examples 10-12, further including identifying objects associated with the educational material in the image data; and modifying the scene to incorporate the identified objects.

Example 14 may include the subject matter of Examples 10-13, further including communicating with a device of the student; analyzing educational content displayed by the device; and modifying the scene based on the analyzed educational content.

Example 15 may include the subject matter of Examples 10-14, and the camera is a depth camera and the image data is 3-Dimensional.

Example 16 may include the subject matter of Examples 10-15, further including receiving input audio data from a microphone and performing speech recognition on the input audio data to further identify the student.

Example 17 may include the subject matter of Examples 10-16, further including generating output audio data through a speaker, the output audio data associated with the selected portions of the educational material.

According to Example 18 there is provided at least one computer-readable storage medium having instructions stored thereon which when executed by a processor result in the following operations for providing educational material in a classroom environment. The operations may include: obtaining image data from a camera; analyzing the image data to identify a student; obtaining educational history associated with the student from a student database; analyzing the image data to identify a projection surface in the environment; generating a scene including selected portions of the educational material based on the identified student and the educational history; and projecting the scene onto the projection surface.

Example 19 may include the subject matter of Example 18, further including estimating a state of attention of the student based on features of the student extracted from the image data, the features including head pose, posture and facial expression; and the selected portions of the educational material are further based on the estimated state of attention.

Example 20 may include the subject matter of Examples 18 and 19, further including estimating gestures of the student based on the image data, the gestures associated with commands; and modifying the scene based on the estimated gestures.

Example 21 may include the subject matter of Examples 18-20, further including identifying objects associated with the educational material in the image data; and modifying the scene to incorporate the identified objects.

Example 22 may include the subject matter of Examples 18-21, further including communicating with a device of the student; analyzing educational content displayed by the device; and modifying the scene based on the analyzed educational content.

Example 23 may include the subject matter of Examples 18-22, and the camera is a depth camera and the image data is 3-Dimensional.

Example 24 may include the subject matter of Examples 18-23, further including receiving input audio data from a microphone and performing speech recognition on the input audio data to further identify the student.

Example 25 may include the subject matter of Examples 18-24, further including generating output audio data through a speaker, the output audio data associated with the selected portions of the educational material.

According to Example 26 there is provided a system for providing educational material in a classroom environment. The system may include: means for obtaining image data from a camera; means for analyzing the image data to identify a student; means for obtaining educational history associated with the student from a student database; means for analyzing the image data to identify a projection surface in the environment; means for generating a scene including selected portions of the educational material based on the identified student and the educational history; and means for projecting the scene onto the projection surface.

Example 27 may include the subject matter of Example 26, further including means for estimating a state of attention of the student based on features of the student extracted from the image data, the features including head pose, posture and facial expression; and the selected portions of the educational material are further based on the estimated state of attention.

Example 28 may include the subject matter of Examples 26 and 27, further including means for estimating gestures of the student based on the image data, the gestures associated with commands; and modifying the scene based on the estimated gestures.

Example 29 may include the subject matter of Examples 26-28, further including means for identifying objects associated with the educational material in the image data; and means for modifying the scene to incorporate the identified objects.

Example 30 may include the subject matter of Examples 26-29, further including means for communicating with a device of the student; means for analyzing educational content displayed by the device; and means for modifying the scene based on the analyzed educational content.

Example 31 may include the subject matter of Examples 26-30, and the camera is a depth camera and the image data is 3-Dimensional.

Example 32 may include the subject matter of Examples 26-31, further including means for receiving input audio data from a microphone and performing speech recognition on the input audio data to further identify the student.

Example 33 may include the subject matter of Examples 26-32, further including means for generating output audio data through a speaker, the output audio data associated with the selected portions of the educational material.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A system for providing educational material, said system comprising:
a camera to obtain image data;
user analysis circuitry to analyze said image data to identify a student and obtain educational history associated with said student;
environmental analysis circuitry to analyze said image data and identify a projection surface;
scene augmentation circuitry to generate a scene comprising selected portions of said educational material based on said identified student and said educational history; and
an image projector to project said scene onto said projection surface.

2. The system of claim 1, wherein said user analysis circuitry further comprises implicit state estimation circuitry to estimate a state of attention of said student based on features of said student extracted from said image data, said features comprising head pose, posture and facial expression; and wherein said selected portions of said educational material are further based on said estimated state of attention.

3. The system of claim 1, wherein said user analysis circuitry further comprises explicit state estimation circuitry to estimate gestures of said student based on said image data, said gestures associated with commands; and said scene augmentation circuitry is further to modify said scene based on said estimated gestures.

4. The system of claim 1, wherein said environmental analysis circuitry further comprises object search circuitry to identify objects associated with said educational material in said image data; and said scene augmentation circuitry is further to modify said scene to incorporate said identified objects.

5. The system of claim 1, further comprising communication circuitry to communicate with a device of said student; and content analysis circuitry to analyze educational content displayed by said device; and said scene augmentation circuitry is further to modify said scene based on said analyzed educational content.

6. The system of claim 1, wherein said camera is a depth camera and said image data is 3-Dimensional.

7. The system of claim 1, further comprising a microphone to obtain input audio data from said student and speech recognition circuitry to further identify said student based on said input audio data.

8. The system of claim 1, further comprising a speaker to generate output audio associated with said selected portions of said educational material.

9. The system of claim 1, wherein said system is a humanoid robot.

10. A method for providing educational material in a classroom environment, said method comprising:
obtaining image data from a camera;
analyzing said image data to identify a student;
obtaining educational history associated with said student from a student database;
analyzing said image data to identify a projection surface in said environment;
generating a scene comprising selected portions of said educational material based on said identified student and said educational history; and
projecting said scene onto said projection surface.

11. The method of claim 10, further comprising estimating a state of attention of said student based on features of said student extracted from said image data, said features comprising head pose, posture and facial expression; and wherein said selected portions of said educational material are further based on said estimated state of attention.

12. The method of claim 10, further comprising estimating gestures of said student based on said image data, said gestures associated with commands; and modifying said scene based on said estimated gestures.

13. The method of claim 10, further comprising identifying objects associated with said educational material in said image data; and modifying said scene to incorporate said identified objects.

14. The method of claim 10, further comprising communicating with a device of said student; analyzing educational content displayed by said device; and modifying said scene based on said analyzed educational content.

15. The method of claim 10, wherein said camera is a depth camera and said image data is 3-Dimensional.

16. The method of claim 10, further comprising receiving input audio data from a microphone and performing speech recognition on said input audio data to further identify said student.

17. The method of claim 10, further comprising generating output audio data through a speaker, said output audio data associated with said selected portions of said educational material.

18. At least one computer-readable storage medium having instructions stored thereon which when executed by a processor result in the following operations for providing educational material in a classroom environment, said operations comprising:
obtaining image data from a camera;
analyzing said image data to identify a student;
obtaining educational history associated with said student from a student database;
analyzing said image data to identify a projection surface in said environment;
generating a scene comprising selected portions of said educational material based on said identified student and said educational history; and
projecting said scene onto said projection surface.

19. The computer-readable storage medium of claim 18, further comprising estimating a state of attention of said student based on features of said student extracted from said image data, said features comprising head pose, posture and facial expression; and wherein said selected portions of said educational material are further based on said estimated state of attention.

20. The computer-readable storage medium of claim 18, further comprising estimating gestures of said student based on said image data, said gestures associated with commands; and modifying said scene based on said estimated gestures.

21. The computer-readable storage medium of claim 18, further comprising identifying objects associated with said educational material in said image data; and modifying said scene to incorporate said identified objects.

22. The computer-readable storage medium of claim 18, further comprising communicating with a device of said student; analyzing educational content displayed by said device; and modifying said scene based on said analyzed educational content.

23. The computer-readable storage medium of claim 18, wherein said camera is a depth camera and said image data is 3-Dimensional.

24. The computer-readable storage medium of claim 18, further comprising receiving input audio data from a microphone and performing speech recognition on said input audio data to further identify said student.

25. The computer-readable storage medium of claim 18, further comprising generating output audio data through a speaker, said output audio data associated with said selected portions of said educational material.
